(19) United States
(12) Patent Application Publication
(10) Pub. No.: US 2026/0195605 A1
(43) Pub. Date: Jul. 9, 2026

(54) A Method of Validating Defense Mechanism of an AI System

(71) Applicants: Robert Bosch GmbH, Stuttgart (DE); Bosch Global Software Technologies Private Limited, Bangalore (IN)

(72) Inventors: Adit Jignesh Shah, Ahmedabad (IN); Manojkumar Somabhai Parmar, Ahmedabad, Gujarat (IN)

(21) Appl. No.: 19/128,302

(22) PCT Filed: Nov. 14, 2023
(86) PCT No.: PCT/EP2023/081760

§ 371 Date: May 8, 2025

(30) Foreign Application Priority Data
Nov. 14, 2022 (IN) 2022 4106 5033

(51) Int. Cl. G06N 3/094; G06N 3/0464

(52) U.S. Cl. CPC G06N 3/094; G06N 3/0464

(57) ABSTRACT

A method and a framework for validating defense mechanism of an AI system is disclosed. The framework includes an AI system in communication with an inverse AI model. The AI system includes an AI model configured to process a range of input queries and give an output and at least a blocker module configured to modify the output when an input query is recognized as an attack vector. The method includes training the inverse AI model on dataset including a set of outputs of known attack vectors and their probability distribution for various classes. A set of attack vectors are generated for various classes by executing the inverse AI model on the dataset. These set of attack vectors are fed as input to the AI model to validate the defense mechanism of the AI system.

### FIELD OF THE INVENTION

The present disclosure relates to a method of validating defense mechanism of an AI system.

### BACKGROUND OF THE INVENTION

With the advent of data science, data processing and decision making systems are implemented using artificial intelligence modules. The artificial intelligence modules use different techniques like machine learning, neural networks, deep learning etc. Most of the AI based systems, receive large amounts of data and process the data to train AI models. Trained AI models generate output based on the use cases requested by the user. Typically the AI systems are used in the fields of computer vision, speech recognition, natural language processing, audio recognition, healthcare, autonomous driving, manufacturing, robotics etc. where they process data to generate required output based on certain rules/intelligence acquired through training.

To process the inputs and give a desired output, the AI systems use various models/algorithms which are trained using the training data. Once the AI system is trained using the training data, the AI systems use the models to analyze the real time data and generate appropriate result. The models may be fine-tuned in real-time based on the results. The models in the AI systems form the core of the system. Lots of effort, resources (tangible and intangible), and knowledge goes into developing these models.

It is possible that some adversary may try to capture/copy/extract the model from AI systems. The adversary may use different techniques to capture the model from the AI systems. One of the simple techniques used by the adversaries is where the adversary sends different queries to the AI system iteratively, using its own test data. There is a need to identify the most effective set of queries in the test data that can efficiently extract internal information about the working of the models in the AI system. The adversary uses the generated results to train its own models. By doing these steps iteratively, it is possible to capture the internals of the model and a parallel model can be built using similar logic. This will cause hardships to the original developer of the AI in the form of business disadvantages, loss of confidential information, loss of lead time spent in development, loss of intellectual properties, loss of future revenues etc. Hence there is a need to identify samples in the test data or generate samples that can efficiently extract internal information about the working of the models and test the defense mechanism of the AI system against those sample-based queries.

There are methods known in the prior arts to identify such attacks by the adversaries and to protect the models used in the AI system. The prior art US 20190095629A1—Protecting Cognitive Systems from Model Stealing Attacks discloses one such method. It discloses a method wherein the input data is processed by applying a trained model to the input data to generate an output vector having values for each of the plurality of pre-defined classes. A query engine modifies the output vector by inserting a query in a function associated with generating the output vector, to thereby generate a modified output vector. The modified output vector is then output. The query engine modifies one or more values to disguise the trained configuration of the trained model logic while maintaining accuracy of classification of the input data.

### BRIEF DESCRIPTION OF THE ACCOMPANYING DRAWINGS

An embodiment of the invention is described with reference to the following accompanying drawings:

FIG. 1 depicts a framework for validating the defense of an AI system (10);

FIG. 2 illustrates method steps of validating defense mechanism of the AI system (10).

### DETAILED DESCRIPTION OF THE DRAWINGS

It is important to understand some aspects of artificial intelligence (AI) technology and artificial intelligence (AI) based systems or artificial intelligence (AI) system. Some important aspects of the AI technology and AI systems can be explained as follows. Depending on the architecture of the implements AI systems may include many components. One such component is an AI module. An AI module with reference to this disclosure can be explained as a component which runs a model. A model can be defined as reference or an inference set of data, which is use different forms of correlation matrices. Using these models and the data from these models, correlations can be established between different types of data to arrive at some logical understanding of the data. A person skilled in the art would be aware of the different types of AI models such as linear regression, naïve bayes classifier, support vector machine, neural networks and the like. It must be understood that this disclosure is not specific to the type of model being executed in the AI module and can be applied to any AI module irrespective of the AI model being executed. A person skilled in the art will also appreciate that the AI module may be implemented as a set of software instructions, combination of software and hardware or any combination of the same.

Some of the typical tasks performed by AI systems are classification, clustering, regression etc. Majority of classification tasks depend upon labeled datasets; that is, the data sets are labelled manually in order for a neural network to learn the correlation between labels and data. This is known as supervised learning. Some of the typical applications of classifications are: face recognition, object identification, gesture recognition, voice recognition etc. Clustering or grouping is the detection of similarities in the inputs. The cluster learning techniques do not require labels to detect similarities. Learning without labels is called unsupervised learning. Unlabeled data is the majority of data in the world. One law of machine learning is: the more data an algorithm can train on, the more accurate it will be. Therefore, unsupervised learning models/algorithms has the potential to produce accurate models as training dataset size grows.

As the AI module forms the core of the AI system, the module needs to be protected against attacks. AI adversarial threats can be largely categorized into—model extraction attacks, inference attacks, evasion attacks, and data poisoning attacks. In poisoning attacks, the adversarial carefully inject crafted data to contaminate the training data which eventually affects the functionality of the AI system. Inference attacks attempt to infer the training data from the corresponding output or other information leaked by the target model. Studies have shown that it is possible to recover training data associated with arbitrary model output. Ability to extract this data further possess data privacy issues. Evasion attacks are the most prevalent kind of attack that may occur during AI system operations. In this method, the attacker works on the AI algorithm's inputs to find small perturbations leading to large modifications of its outputs (e.g., decision errors) which leads to evasion of the AI model.

In Model Extraction Attacks (MEA), the attacker gains information about the model internals through analysis of input, output, and other external information. Stealing such a model reveals the important intellectual properties of the organization and enables the attacker to craft other adversarial attacks such as evasion attacks. This attack is initiated through an attack vector. In the computing technology a vector may be defined as a method in which a malicious code/virus data uses to propagate itself such as to infect a computer, a computer system or a computer network. Similarly, an attack vector is defined a path or means by which a hacker can gain access to a computer or a network in order to deliver a payload or a malicious outcome. A model stealing attack uses a kind of attack vector that can make a digital twin/replica/copy of an AI module.

The attacker typically generates random queries of the size and shape of the input specifications and starts querying the model with these arbitrary queries. This querying produces input-output pairs for random queries and generates a secondary dataset that is inferred from the pre-trained model. The attacker then take this I/O pairs and trains the new model from scratch using this secondary dataset. This is a black box model attack vector where no prior knowledge of original model is required. As the prior information regarding model is available and increasing, attacker moves towards more intelligent attacks.

The attacker chooses relevant dataset at his disposal to extract model more efficiently. Our aim through this disclosure is to identify queries that give the best input/output pair needed to train the model. Once the set of queries in the dataset that can efficiently steal the model are identified, we test the defense mechanism of the AI system against those queries.

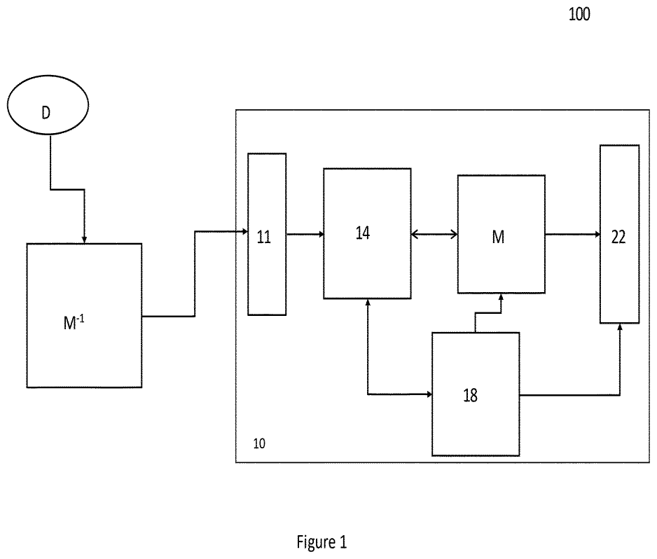

FIG. 1 depicts a framework for validating defense mechanism of an AI system (10). The AI system (10) is configured to process a range of input queries by means of AI Model (M) and give an output. The AI system (10) comprises an AI Model (M), submodule (14) and at least a blocker module (18) amongst other components known to a person skilled in the art such as the input interface (11), output interface (22) and the like. For simplicity only components having a bearing on the methodology disclosed in the present invention have been elucidated. The submodule (14) is configured to recognize an attack vector from amongst the input queries.

The submodule (14) is configured to identify an attack vector It can be designed or built-in multiple ways to achieve in ultimate functionality of identifying an attack vector from amongst the input. In an embodiment the submodule (14) comprises at least two AI models and a comparator. The said at least two or more models could be any from the group of linear regression, naïve Bayes classifier, support vector machine, neural networks and the like. However at least one of the models is the same as the one executed by the AI Model. For example if the AI Model executes a convolutional neural network (CNN) model, at least one module inside the submodule (14) will also execute the CNN model. The input query is passed through these at least two models and then their result is compared by the comparator to identify an attack vector from amongst the input queries.

In another embodiment of the AI system (10), the submodule (14) additionally comprises a pre-processing block that transposes or modifies the fidelity of input it receives into at least two subsets. These subsets are then fed to the said at least two models and theirs results compared by the comparator. In another embodiment the submodule adds a pre-defined noise to the input data and compares the output of the noisy input and normal input fed to the AI Model (M). Likewise, there are multiple embodiments of the submodule (14) configured to identify an attack vector from amongst the input.

The AI system (10) further comprises at least a blocker module (18) configured to block a user when the submodule (14) recognizes the input query as an attack vector. The blocker module (18) is configured to identify the input fed to AI model as attack vector. In an exemplary embodiment of the present invention, it receives this attack vector identification information from the submodule (14). It is further configured to modify the original output generated by the AI Model (M) on identification of attack vector for successful validation of the defense of the AI system (10).

This AI system (10) in communication with the inverse AI model (M⁻¹). The inverse AI model (M−1)(some more info on back-progation and de-convulation) is configured to generate a set of attack vectors for various classes using a set of outputs of known attack vectors, their probability distribution, and their corresponding class. The inverse AI model (M⁻¹) is built using generative techniques.

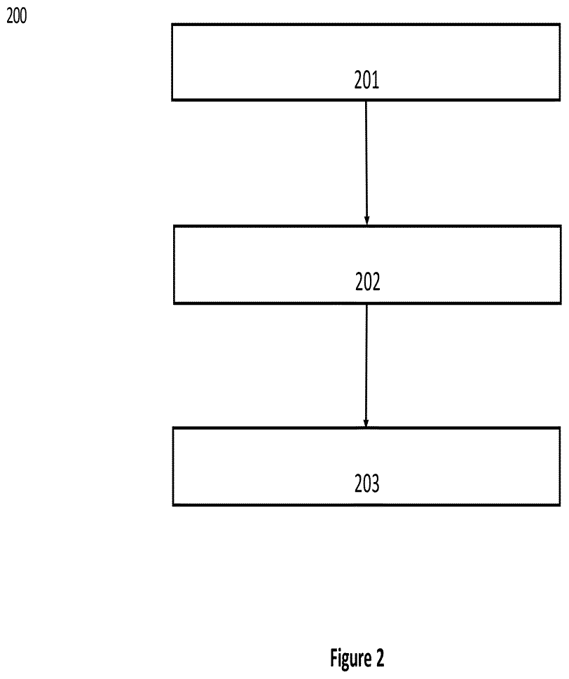

FIG. 2 illustrates method steps (200) of validating defense mechanism of the AI system (10). The AI system (10) and its components have been explained in accordance with FIG. 1. For the purposes of clarity, it is reiterated that the AI system comprises at least an AI model (M) and a blocker module (18), said AI model (M) configured to process a range of input queries and give an output, the blocker module (18) is configured to modify the output when an input query is recognized as an attack vector, said AI system (10) in communication with an inverse AI model (M⁻¹).

In step 201, the inverse AI model (M⁻¹) is trained using the dataset (D) comprising set of outputs of known attack vectors and their probability distribution for various classes. The training dataset (D) is a small no. of outputs of known attack vectors. In step 202, a set of attack vectors is generated for various classes by executing the inverse AI model (M⁻¹) on the dataset (D). Using a small no. of known outputs of attack vectors a large no. of attack vectors are generated. The inverse AI model uses AI and machine learning algorithms to enable machines to generate artificial yet new content (in this case attack vectors). In step 203, generated set of attack vectors are fed as input to the AI model (M) to validate the defense mechanism of the AI system (10).

A successful validation the defense mechanism of the AI system (10) further comprises identifying the input fed to AI model (M) as attack vector by the blocker module (18). This identification information, in an exemplary embodiment of the AI model (M) is received from the submodule (14). Further a successful validation of the defense mechanism comprises modifying the original output generated by the AI model (M) by the blocker module (18).

Using these method step (200), the aim is to decrease the number of queries and have a potential exposure to data used for training the original model (M). Essentially, the idea is to use limited no. of pre-determined set of attack vector to get the predicted result. Then the output probability is taken to train the inverse model (M⁻¹). The inverse model (M⁻¹) is made using generative techniques or de-convolution and up sampling the layers in the model. This model is then taken to form more inputs using the probability value for various classes. This is done by maximizing the value of one of the class. The provided output is then used as a reference to create more queries of the same kind.

It must be understood that the disclosure in particular discloses methodology used for validating defense mechanism of an AI system (10). While these methodologies describes only a series of steps to accomplish the objectives, these methodologies are implemented in AI system (10), which may be a combination of hardware, software and a combination thereof.

It must be understood that the embodiments explained in the above detailed description are only illustrative and do not limit the scope of this invention. Any modification the framework and adaptation of the method for validating defense mechanism of an AI system (10) are envisaged and form a part of this invention. The scope of this invention is limited only by the claims.

1. A method of validating defense mechanism of an AI system, the AI system comprising at least an AI model and a blocker module, wherein said AI model is configured to process a range of input queries and give an output, and the blocker module is configured to modify the output when an input query is recognized as an attack vector, and wherein said AI system is in communication with an inverse AI model, the method comprising:
training the inverse AI model using a dataset comprising a set of outputs of known attack vectors and their probability distribution for various classes;
generating a set of attack vectors for various classes by executing the inverse AI model on the dataset; and
feeding the generated set of attack vectors as input to the AI model to validate the defense mechanism of the AI system.

2. The method as claimed in claim 1, wherein the inverse AI model is built using de-convolution and up sampling the layers in the AI model.

3. The method as claimed in claim 1, wherein successful validation the defense mechanism of the AI system further comprises:
identifying the input fed to the AI model as attack vector by the blocker module; and
modifying the original output generated by the AI model by the blocker module.

4. A framework for validating the defense mechanism of an AI system, the framework comprising:
said AI system the AI system comprising at least an AI model and a blocker module, wherein said AI model is configured to process a range of input queries and give an output, and wherein the blocker module is configured to modify the output when an input query is recognized as an attack vector; and
an inverse AI model that is in communication with the AI system, wherein the inverse AI model is configured to generate a set of attack vectors for various classes using a set of outputs of known attack vectors, their probability distribution, and their corresponding class.

5. The framework as claimed in claim 4, wherein the inverse AI model is built using generative techniques.

6. The framework mechanism as claimed in claim 4, wherein the blocker module is configured to:
identify the input fed to the AI model as attack vector; and
modify the original output generated by the AI model on identification of attack vector for successful validation of the defense of the AI system.
